(19) United States
(12) Patent Application Publication
(10) Pub. No.: US 2026/0054217 A1
(43) Pub. Date: Feb. 26, 2026

(54) ELECTROCHEMICAL COMPRESSION FOR HYDROGEN RECOVERY AND HIGH PLANT YIELD IN AMMONIA SYNTHESIS PROCESSES

(71) Applicant: Ohmium International, Inc., 39672 Eureka Dr., CA (US)

(72) Inventors: Chockkalingam Karuppaiah, Fremont, CA (US); Marta Lema Garabatos, Madrid (ES); Arne Ballantine, Incline Village, NV (US)

(21) Appl. No.: 19/300,184

(22) Filed: Aug. 14, 2025

Related U.S. Application Data
(60) Provisional application No. 63/685,990, filed on Aug. 22, 2024.

(51) Int. Cl. B01D 53/32; B01D 53/22; B01D 69/14; B01D 71/02; B01D 71/32; B01J 4/00; B01J 12/00; B01J 19/24; C01C 1/04; C25B 1/27; F04B 43/04; F04B 53/20; H01M 8/0662

(52) U.S. Cl. CPC B01D 53/326; B01D 53/229; B01D 69/148; B01D 71/024; B01D 71/32; B01J 4/001; B01J 12/00; B01J 19/245; C01C 1/0417; C25B 1/27; F04B 43/04; F04B 53/20; H01M 8/0681; H01M 8/0687; B01D 2256/16; B01J 2204/005

(57) ABSTRACT

Systems and methods for synthesizing ammonia include one or more electrochemical hydrogen pumps to recover excess hydrogen gas from the ammonia synthesis product stream. The systems and methods improve overall yield and efficiency of the ammonia production process by separating and purifying hydrogen gas that otherwise would be lost.

### CROSS-REFERENCE TO RELATED APPLICATIONS

This application claims priority to U.S. Provisional Application No. 63/685,990 filed Aug. 22, 2024, titled “Electrochemical Compression for Hydrogen Recovery and High Plant Yield in Ammonia Synthesis Processes,” the entire contents of which are incorporated by reference herein.

### FIELD OF THE DISCLOSURE

The present disclosure is related to systems and methods for synthesizing ammonia with improved recovery of hydrogen.

### BACKGROUND

Ammonia synthesis economics are highly sensitive to energy input costs. These costs pass directly to the production cost of the output ammonia product and can determine whether a given ammonia plant project is feasible or infeasible on the basis of economics. Valuable gas purging, such as nitrogen and hydrogen purging in the latter half of the typical ammonia synthesis processes, increases costs on a proportional basis. If these expenses could be avoided, then overall ammonia synthesis costs would be reduced.

In ammonia synthesis processes of the state of the art, a portion of the valuable gas streams is vented at a plurality of points in the synthesis and dispensing processes of ammonia plants. The reasons for these losses vary but include the elimination of inert gases such as argon or helium, which come from air or natural gas that are used as conventional process inputs. These gases build up in the recirculated processes such as the Haber Bosch process and the purge streams allow for removal of the inert gases. Further, even in green hydrogen ammonia synthesis processes, it is the case that argon from air will be present (the helium being mitigated by the direct use of hydrogen instead of natural gas).

In Haber Bosch processes of the prior art, pressurized membrane assemblies such as diffusion-selectivity-based membranes are used to recover a percentage (such as 90%) of the hydrogen in a purge gas stream. This recovered hydrogen may be utilized in the plant for thermal use or directed back to the process input. However, in this case, 10% of the purge stream's value is not directly recovered. Further, other downstream losses are not captured with this type of equipment because the requisite gas pressure is not present.

Valuable gases are also lost in the flash gas stream. The stream results from liquid ammonia separation before storage to remove dissolved gases. In the flash gas stream, recovery of valuable hydrogen is generally not utilized in ammonia plants.

### SUMMARY OF THE DISCLOSURE

Provided herein are methods for recovering hydrogen gas in ammonia production systems. The methods generally include reacting hydrogen gas and nitrogen gas in a reactor to produce a product gas stream comprising ammonia and excess hydrogen gas; separating the ammonia from the product gas stream; separating the excess hydrogen gas from the product gas stream using an electrochemical hydrogen pump to recover the excess hydrogen gas to recover the excess hydrogen gas; and compressing the excess hydrogen gas using the electrochemical hydrogen pump. The methods may also generally include reacting hydrogen gas and nitrogen gas to produce a gas stream comprising ammonia and excess hydrogen gas; separating the excess hydrogen gas from the gas stream using an electrochemical hydrogen pump to recover the excess hydrogen gas; and compressing the excess hydrogen gas using the electrochemical hydrogen pump.

Further provided herein are systems for ammonia synthesis. The systems generally include a reactor for producing a product gas stream comprising ammonia, the reactor fluidly connected to a hydrogen source and a nitrogen source; a flash vessel fluidly connected to the reactor for separating ammonia from the product gas stream, thereby producing a separated gas stream; and an electrochemical hydrogen pump fluidly connected to the flash vessel to separate excess hydrogen gas from the separated gas stream and to compress the excess hydrogen gas.

Further provided herein are electrochemical hydrogen pumps for use in the systems and methods described herein. The electrochemical hydrogen pumps generally include a membrane disposed between an anode and a cathode, the membrane comprising one or more proton-conducting materials and one or more ammonia-blocking materials.

Further provided herein are ammonia synthesis devices for producing ammonia in the systems of the present disclosure. The ammonia synthesis devices generally include an ammonia synthesis reactor to generate a product gas stream comprising ammonia, excess hydrogen gas, and excess nitrogen gas; a membrane fluidly connected with the electrochemical ammonia synthesis reactor to separate ammonia from the product gas stream; and an electrochemical hydrogen pump to separate excess hydrogen gas from the product gas stream and compress the excess hydrogen gas.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale, and certain elements such as pumps, valves, pipes, instrumentation, and other elements are not shown but would be recognized as being present by a person having ordinary skill in the art.

FIG. 1 shows a system of the state of the art for synthesizing ammonia.

FIG. 2 shows a system of the present disclosure for synthesizing ammonia and recovering hydrogen gas. The system includes an electrochemical hydrogen pump to compress and purify hydrogen gas collected after separating ammonia from the product gas.

FIG. 3 shows a system of the present disclosure for synthesizing ammonia and recovering hydrogen gas. The system includes an electrochemical hydrogen pump to compress and purify hydrogen gas collected after separating ammonia from the product gas and an electrochemical hydrogen pump to compress and purify hydrogen gas collected after separating hydrogen gas from the product gas via a membrane diffusion-type separator.

FIG. 4 shows a system of the present disclosure for synthesizing ammonia and recovering hydrogen gas. The system includes an electrochemical hydrogen pump to compress and purify hydrogen gas from the product stream.

FIG. 5 shows a system of the present disclosure for synthesizing ammonia and recovering hydrogen gas. The system includes an electrochemical hydrogen pump to compress and purify hydrogen gas from the product stream and an electrochemical hydrogen pump to compress and purify hydrogen gas collected after separating ammonia from the product gas.

FIG. 6 shows a method for separating excess hydrogen gas from the product gas stream of an ammonia synthesis process.

FIG. 7 shows another method for separating excess hydrogen gas from the product gas stream of an ammonia synthesis process.

FIG. 8 shows another method for separating excess hydrogen gas from the product gas stream of an ammonia synthesis process.

FIG. 9 shows a flow diagram for an ammonia synthesis device of the present disclosure.

FIG. 10 shows a diagram of a composite membrane for use in an ammonia synthesis device of the present disclosure.

### DETAILED DESCRIPTION

Described herein are systems, methods, and devices for producing ammonia and recovering hydrogen gas used during the ammonia production. The systems, methods, and devices described herein utilize an electrochemical hydrogen pump to effectively separate hydrogen gas in the product stream of the ammonia production, thereby reducing the overall need for hydrogen production in the system. This also eliminates potential environmental hazards from releasing hydrogen gas to the environment.

### I. Systems

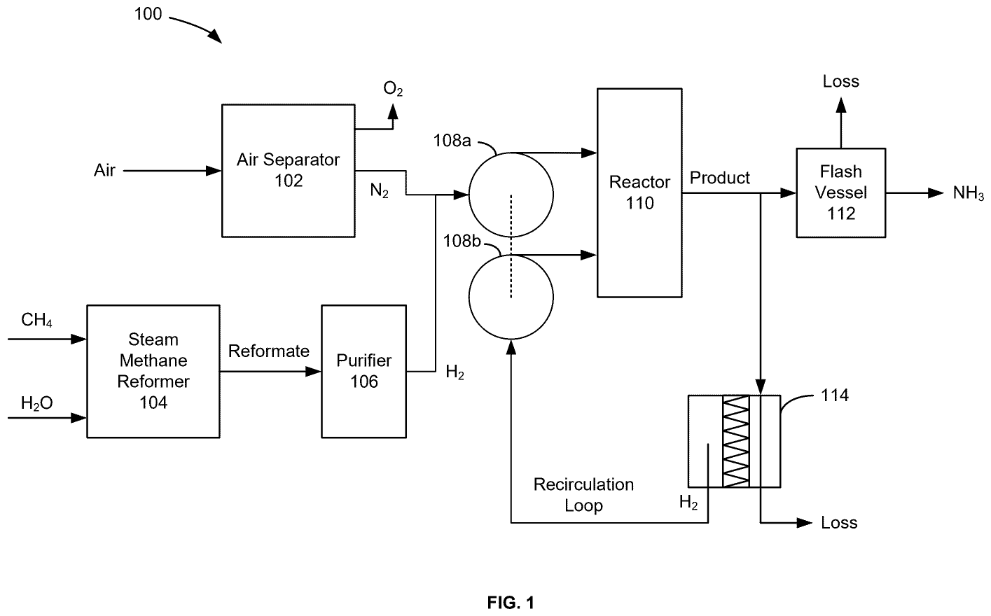

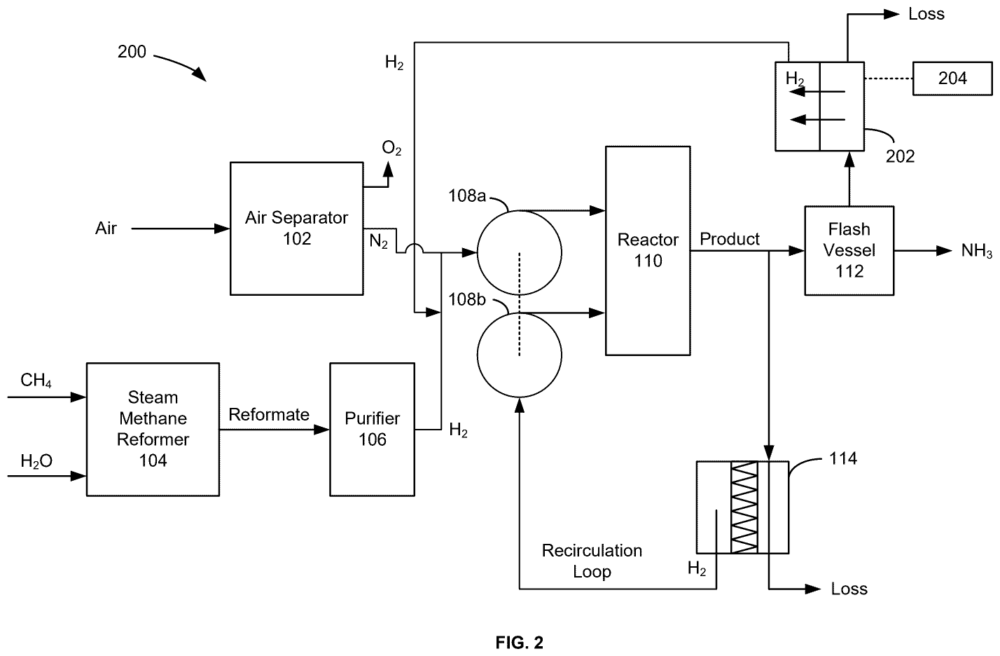

Provided herein are systems for synthesizing ammonia. A system 100 representing the state of the art is shown in FIG. 1. While the system 100 represents the state of the art, aspects of the system 100 such as the system components and process conditions described with respect to the system 100 may be used in any of the systems described further herein with respect to FIGS. 2-4. The system 100 includes a nitrogen (N₂) source and a hydrogen (H₂) source. In the embodiment shown in FIG. 1, the nitrogen source comprises an air separator 102 that separates nitrogen gas from the air. Other nitrogen sources known in the art may be used in other embodiments of the system to provide nitrogen gas, such as compressed nitrogen.

In the embodiment shown in FIG. 1, the hydrogen source comprises a steam methane reformer 104. Steam methane reformers and methods for making and/or procuring the same are generally known in the art. Other hydrogen sources known in the art may be used in other embodiments of the system to provide hydrogen gas, such as an electrolyzer, compressed hydrogen, and the like.

The steam methane reformer 104 is fluidly connected to a purifier 106 to remove impurities from the hydrogen gas produced by the steam methane reformer 104. The purifier may include, e.g., an electrochemical hydrogen pump to separate hydrogen gas from other impurities discussed in more detail below. The purifier may also include a pressure swing adsorption (PSA) system, a temperature swing adsorption (TSA) system, or a hybrid PSA-TSA system. The purifier 106 may be optionally included when the hydrogen source is different from the steam methane reformer. For example, if the hydrogen source comprises an electrolyzer, the level of impurities in the hydrogen gas may be sufficiently low such that the purifier 106 is not needed and therefore is not included in the system.

The hydrogen gas and the nitrogen gas may then combined and pressurized in a compressor 108a. Accordingly, the nitrogen source (the air separator 102) is fluidly connected to the compressor 108a; similarly, the hydrogen source (the steam methane reformer 104 and the purifier 106) is also fluidly connected to the compressor 108a. Preferably, the compressor 108a comprises a multi-stage compressor; however, any compressor known in the art may be used.

The compressor 108a is fluidly connected to a reactor 110 and feeds the hydrogen gas and nitrogen gas into the reactor 110. The reactor 110 chemically reacts the hydrogen gas and the nitrogen gas to form ammonia gas (NH₃). Such reactors and methods of making and procuring the same are well known in the art, and typically operate by conducting a Haber-Bosch reaction to produce ammonia (i.e., a Haber-Bosch reactor). The reactor 110 produces a product gas that includes ammonia, excess hydrogen, and excess nitrogen. The reactor may be an electrochemical ammonia synthesis reactor. The reactor may be an ammonia synthesis device described in Section IV below.

It will also be understood by those having ordinary skill in the art and although not shown in FIG. 1, some embodiments do not include a compressor 108a and the hydrogen gas and nitrogen gas are fed directly into the reactor 110. In such embodiments, the hydrogen source and the nitrogen source are each fluidly connected directly to the reactor 110.

The product gas is then split into two streams. A stream of the product gas is fed to a flash vessel 112 to separate and purify the ammonia from the product gas, thereby producing a separated gas stream. The flash vessel 112 is therefore fluidly connected to the reactor 110. Flash vessels capable of separating and purifying ammonia from a product gas mixture including hydrogen and oxygen gas and methods for making and procuring the same are generally known in the art. The separated gas stream comprising excess hydrogen, nitrogen gas, and any other impurities may be released to the atmosphere or otherwise treated prior to release to the atmosphere. The impurities in the separated gas stream may include low levels of ammonia, oxygen, and other gases.

The remaining product gas is separated in a membrane diffusion-type separator 114. The membrane diffusion-type separator 114 separates the hydrogen gas from the product gas using a diffusion-type membrane. The membrane may include a polymeric membrane such as a perfluorosulfonic acid ionomer; however, other membrane types known in the art may also be used for this purpose. The separated hydrogen gas is then recycled to an inlet of the reactor 110, and may be compressed in a second compressor 108b. The second compressor 108b may have same structure and configuration as the first compressor 108a, or it may be different. The second compressor 108b pressurizes the recirculated hydrogen gas prior to feeding it to the reactor 110. Accordingly, the membrane diffusion-type separator 114 is fluidly connected to the reactor 110 and/or to the second compressor 108b. The remaining hydrogen gas, nitrogen gas, and any other impurities may be released to the atmosphere or otherwise treated prior to release to the atmosphere. A second compressor (not shown) may be required to pressurize the hydrogen separated by the membrane diffusion-type separator 114 prior to feeding it into the reactor 110.

The system further comprises a recirculation loop. The recirculation loop recirculates a fraction of the product gas stream from an outlet of the reactor 110 to an inlet of the reactor 110. Accordingly, the recirculation loop is fluidly connected to an outlet of the reactor 110 and to an inlet of the reactor 110.

Provided herein are systems such as those shown in FIGS. 2-4, which recover additional hydrogen gas from the product gas stream as compared with those systems of the state of the art described above with respect to FIG. 1.

The system 200 shown in FIG. 2 differs from that of FIG. 1 in that an electrochemical hydrogen pump 202 is fluidly connected to the flash vessel 112. As used in this context, an electrochemical pump shall be understood to include a membrane, such as a proton exchange membrane (i.e., a PEM electrolyte) disposed between an anode and a cathode. Electrochemical hydrogen pumps generate protons moveable from the anode through the proton exchange membrane to the cathode form pressurized hydrogen.

The electrochemical hydrogen pump 202 in the system 200 receives the separated gas stream comprising hydrogen gas, nitrogen gas, and other impurities from the flash vessel 112 and separates and pressurizes the hydrogen gas. Although only a single instance of an electrochemical hydrogen pump is shown in FIG. 2, it should be understood that multiple electrochemical hydrogen pumps may be connected in series to further increase compression and purity of the hydrogen gas. Electrochemical hydrogen pumps known for this purpose and methods for procuring and making the same are generally known in the art. The electrochemical hydrogen pump may be a proton exchange membrane (PEM)-type cell, or may be a high-temperature PEM-type cell. These cell types are better able to tolerate traces of ammonia entering the cell by electrochemically oxidizing the ammonia. In some embodiments, the electrochemical hydrogen pump may be an electrochemical hydrogen pump described in Section III below. The electrochemical hydrogen pump 202 may purify the hydrogen gas to a purity of greater than 99%, such 99.9% or greater, 99.99% or greater, or 99.999% or greater. The electrochemical hydrogen pump 202 may compress the hydrogen gas from an input pressure of about 1 bar to an outlet pressure of up to about 30 bar.

The electrochemical hydrogen pump 202 is electrically connected to a power source 204. The power source 204 may include an electricity grid (e.g., a regional electricity grid, a municipal electricity grid, or a microgrid). The power source 204 may include an intermittent source such as solar power (including photovoltaic and reflective), wind power, tidal power, wave power, and other intermittent energy sources known in the art. In some embodiments, the power source 204 may include a fuel cell or a fuel cell stack, wherein the fuel cell or fuel cell stack utilizes hydrogen produced by the hydrogen source and/or hydrogen purified and compressed by the electrochemical hydrogen pump 202.

The hydrogen gas separated and purified by the electrochemical hydrogen pump 202 may then be recirculated to the reactor 110. Accordingly, the electrochemical hydrogen pump 202 is fluidly connected to the reactor 110 and the second compressor 108b. The remaining hydrogen gas, nitrogen gas, and any other impurities may be released to the atmosphere or otherwise treated prior to release to the atmosphere.

The system may further include one or more humidifiers to humidify the gas prior to feeding the gas to the electrochemical hydrogen pump 202. Accordingly, the one or more humidifiers (not shown) are fluidly connected to the electrochemical hydrogen pump 202. Humidifiers suitable for this purpose and methods for making and procuring the same are generally known in the art.

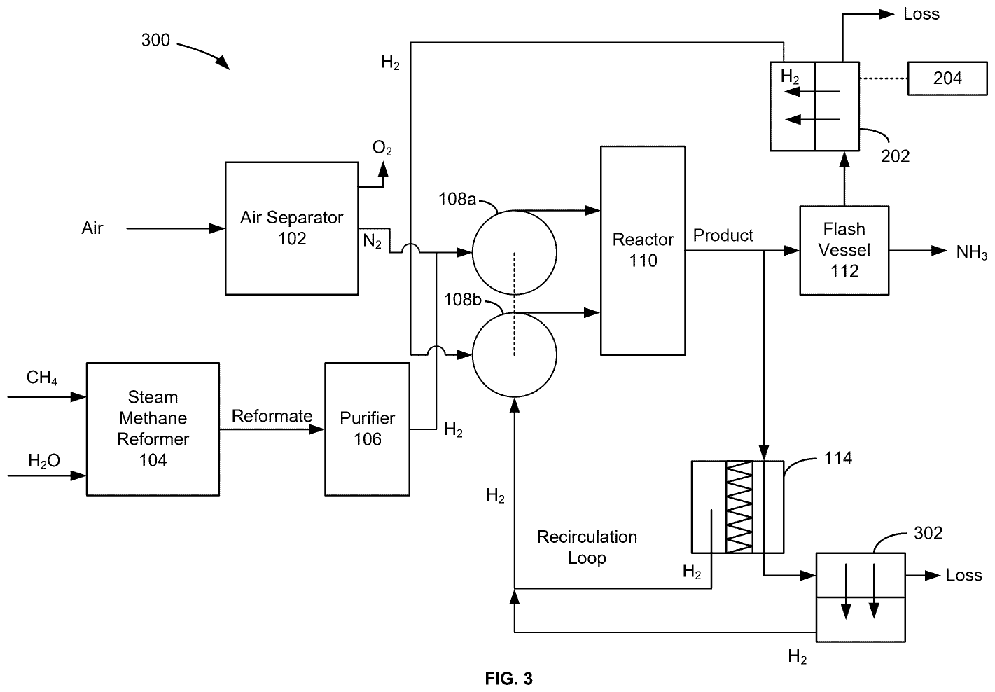

Turning now to FIG. 3, the system 300 differs from the system 200 of FIG. 2 in that the system 300 includes a second electrochemical hydrogen pump 302. The second electrochemical hydrogen pump 302 may be the same configuration as the electrochemical hydrogen pump 202, or it may have a different configuration (e.g., different size, membrane electrolyte, etc.). The second electrochemical hydrogen pump 302 is fluidly connected to the membrane diffusion-type separator 114 and receives hydrogen gas and other gases from the membrane diffusion-type separator 114. The second electrochemical hydrogen pump 302 separates and compresses the hydrogen gas, which is then recycled and combined with the hydrogen gas produced by the hydrogen source before being fed to the reactor 110. Accordingly, the second electrochemical hydrogen pump 302 is fluidly connected to the reactor 110, and the second compressor 108b. The second electrochemical hydrogen pump 302 may purify the hydrogen gas to a purity of greater than 99%, such 99.9% or greater, 99.99% or greater, or 99.999% or greater. The second electrochemical hydrogen pump 302 may compress the hydrogen gas from an input pressure of about 1 bar to an outlet pressure of up to about 30 bar. The remaining hydrogen gas, nitrogen gas, and any other impurities may be released to the atmosphere or otherwise treated prior to release to the atmosphere.

The second electrochemical hydrogen pump 302 may be electrically connected to a power source (not shown). The power source may be power source 204 or it may be a different power source.

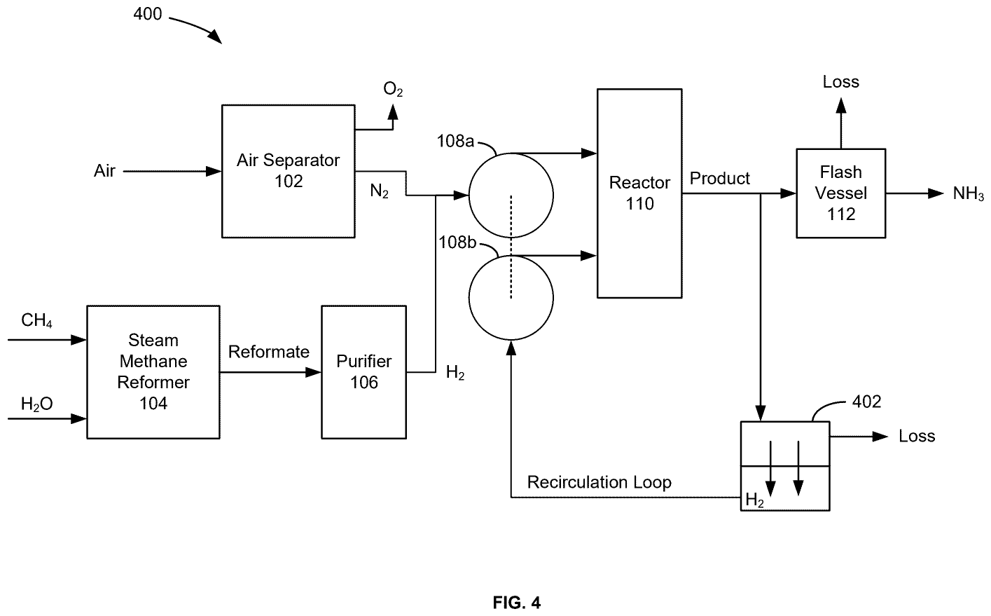

Turning now to FIG. 4, the system 400 differs from the system 100 of FIG. 1 in that the system 400 includes an electrochemical hydrogen pump 402 instead of a membrane diffusion-type separator to purify and compress the hydrogen gas from the product gas stream. The electrochemical hydrogen pump 402 may have the same configuration as the electrochemical hydrogen pump 202 or the second electrochemical hydrogen pump 302 described above. The electrochemical hydrogen pump 402 may purify the hydrogen gas to a purity of greater than 99%, such 99.9% or greater, 99.99% or greater, or 99.999% or greater. The electrochemical hydrogen pump 402 may compress the hydrogen gas from an input pressure of about 1 bar to an outlet pressure of up to about 30 bar. The remaining hydrogen gas, nitrogen gas, and any other impurities may be released to the atmosphere or otherwise treated prior to release to the atmosphere.

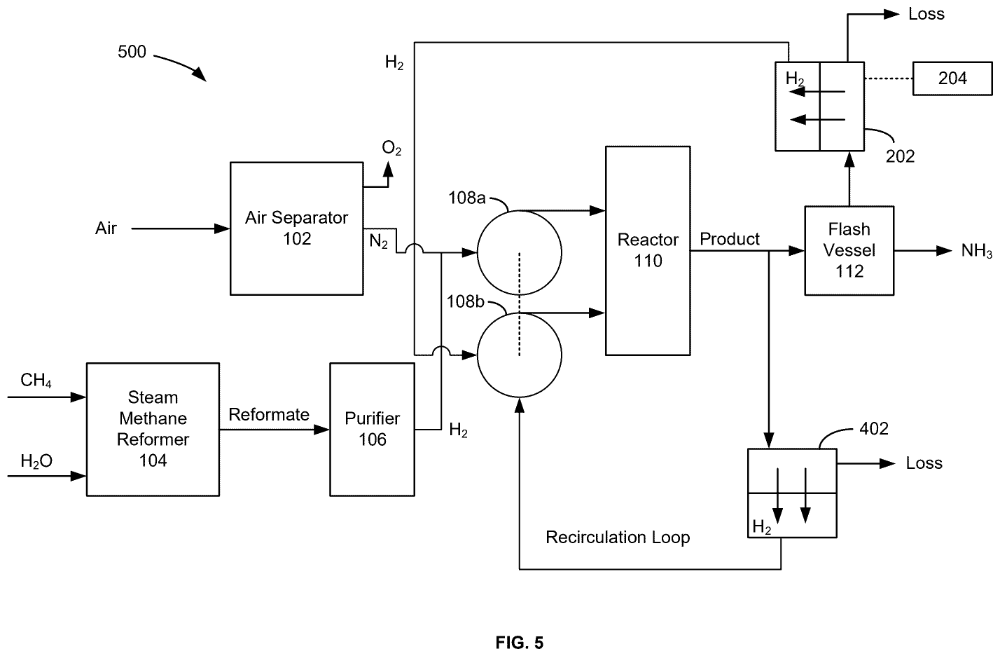

Turning now to FIG. 5, the system 500 differs from the system 100 of FIG. 1 in that the system 500 includes an electrochemical hydrogen pump 402 instead of a membrane diffusion-type separator to purify and compress the hydrogen gas from the product gas stream and further includes an electrochemical hydrogen pump 202 to receive the excess hydrogen gas, nitrogen gas, and other impurities from the flash vessel 112 and separates and pressurizes the excess hydrogen gas. Accordingly, the electrochemical hydrogen pump 402 is fluidly connected to the reactor 110 and to the second compressor 108b, and the electrochemical hydrogen pump 202 is fluidly connected to the flash vessel 112 and the reactor 110 and to the second compressor 108b. The electrochemical hydrogen pump 402 and the electrochemical hydrogen pump 202 may each purify the hydrogen gas to a purity of greater than 99%, such 99.9% or greater, 99.99% or greater, or 99.999% or greater. The electrochemical hydrogen pump 402 and the electrochemical hydrogen pump 202 may each compress the hydrogen gas from an input pressure of about 1 bar to an outlet pressure of up to about 30 bar. The remaining excess hydrogen gas, nitrogen gas, and any other impurities may be released to the atmosphere or otherwise treated prior to release to the atmosphere.

### II. Methods

Further provided herein are methods for recovering hydrogen in an ammonia production system. The methods include separating excess hydrogen gas and compressing the excess hydrogen gas using an electrochemical hydrogen pump, thereby recovering the excess hydrogen gas. The methods described herein may be utilized in any of the systems described in Section I above. In any of the methods described, recovered excess hydrogen may be reused in the reactor to synthesize additional ammonia, and/or the recovered hydrogen may be used to fuel a fuel cell to power one or more systems in the ammonia production plant. In some embodiments, all of the recovered excess hydrogen gas may be reused in the reactor. In other embodiments, at least a fraction of the excess hydrogen gas may be used to fuel a fuel cell to power one or more systems in the ammonia production plant.

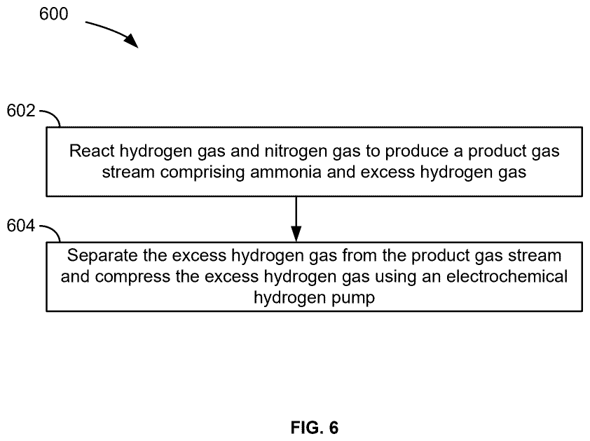

Referring now to FIG. 6, the method 600 generally includes step 602 reacting hydrogen gas and nitrogen gas to produce a product gas stream comprising ammonia and excess hydrogen gas; and step 604 separating the excess hydrogen gas from the product gas stream and compressing the excess hydrogen gas using an electrochemical hydrogen pump, thereby recovering the excess hydrogen. Reacting the hydrogen gas and nitrogen gas to produce a product gas stream comprising ammonia and excess hydrogen gas may be accomplished in a reactor, such as a Haber-Bosch reactor. Any reactor described in Section I above may be suitable for this purpose. The electrochemical hydrogen pump may be any electrochemical hydrogen pump as described in Section I above. Separating the excess hydrogen gas and compressing the excess hydrogen gas are accomplished simultaneously by using the electrochemical hydrogen pump.

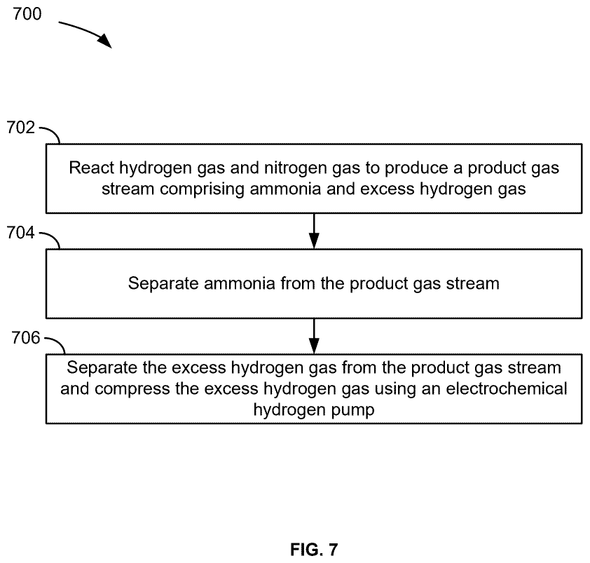

Referring now to FIG. 7, the method 700 may include step 702 reacting hydrogen gas and nitrogen gas to produce a product gas stream comprising ammonia and excess hydrogen gas; step 704 separating ammonia from the product gas stream; and step 706 separating the excess hydrogen gas from the product gas stream and compressing the excess hydrogen gas using an electrochemical hydrogen pump. Step 704 may be accomplished by using, e.g., a flash vessel to flash the product gas stream, thereby separating liquid ammonia from the excess hydrogen gas and other gases. Any flash vessel described above in Section I may be suitable for this purpose.

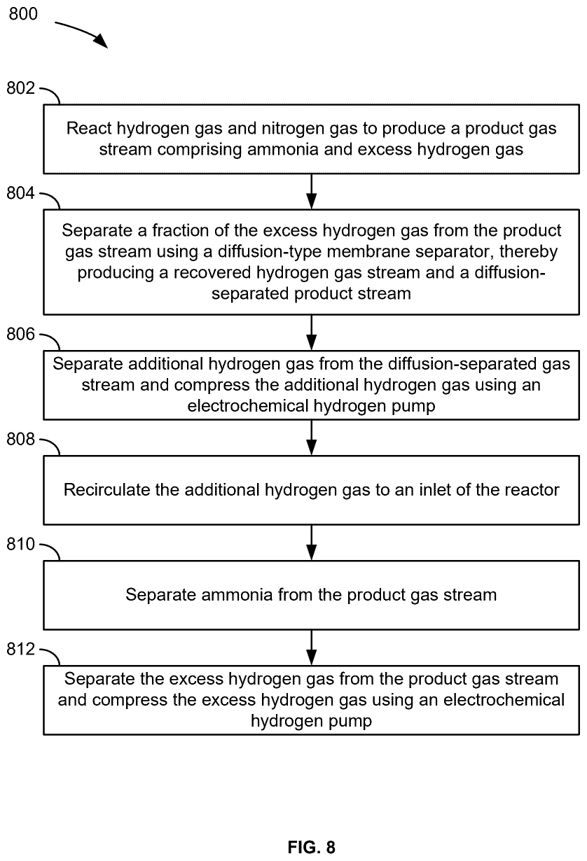

Referring now to FIG. 8, the method 800 may include step 802 reacting hydrogen gas and nitrogen gas to produce a product gas stream comprising ammonia and excess hydrogen gas; step 804 separating a fraction of the excess hydrogen gas from the product gas stream using a diffusion-type membrane separator, thereby producing a recovered hydrogen gas stream and a diffusion-separated product stream; step 806 separating additional hydrogen gas from the diffusion-separated gas stream and compressing the additional hydrogen gas using an electrochemical hydrogen pump; step 808 recirculating the additional hydrogen gas to an inlet of the reactor; step 810 separating ammonia from the product gas stream; and step 812 separating the excess hydrogen gas from the product gas stream and compress the excess hydrogen gas using an electrochemical hydrogen pump.

Step 804 may be conducted using any of the diffusion-type membrane separators described in Section I above. The diffusion-separated product stream may comprise hydrogen and other impurities from the product gas stream. The diffusion-separated product stream may be fluidly connected to an inlet of the reactor and, when present, to a compressor. The diffusion-separated product stream may be further purified to remove any impurities prior to being recycled to the reactor. Alternatively, the diffusion-separated product stream may be used to fuel a fuel cell to power one or more systems in the ammonia production plant.

Step 806 is accomplished using an electrochemical hydrogen pump to separate additional hydrogen gas from the diffusion-separated product stream. Any of the electrochemical hydrogen pumps discussed in Section I above may used. The additional hydrogen gas refers to the excess hydrogen gas separated from the product stream by the diffusion-type membrane separator.

Step 808 may be accomplished in a recirculation loop as shown in FIGS. 2-5. The recirculation loop may improve the overall yield of the ammonia synthesis process, which, for Haber-Bosch reactions, generally has a single-pass yield of about 10-15%. By recirculating the hydrogen gas recovered from the product gas, the overall yield of the ammonia synthesis reaction may be increased.

Step 810 may be accomplished by using a flash vessel 112 as shown in FIGS. 2-5. Once separated, the ammonia may be stored for further use or transport.

Step 812 may be accomplished using an electrochemical hydrogen pump 202 as shown in FIGS. 2, 3, and 5. The electrochemical hydrogen pump 202 may compress the separated hydrogen from about 1 bar up to about 30 bar.

Any of the methods described above may further include humidifying the product gas stream, the excess hydrogen gas stream, the diffusion-separated product stream, or any other stream prior to separating excess hydrogen gas and compressing excess hydrogen gas in an electrochemical hydrogen pump. The increased humidity of the stream may improve the separation of the excess hydrogen gas in the electrochemical hydrogen pump. The humidifier may humidify the stream to a relative humidity from about 90% to about 100%.

Any of the methods described above may further include releasing to the environment any remaining unpurified or nonseparated gases from the product gas stream. Further, any of the methods described above may further include treating the any remaining unpurified or nonseparated gases from the product gas stream prior to releasing the same to the environment. The treatment may include scrubbing, absorbing, stripping, or other methods known in the art.

### III. Electrochemical Hydrogen Pump

Further provided herein are electrochemical hydrogen pumps suitable for use in the systems and methods of the present disclosure. The electrochemical hydrogen pump includes a membrane disposed between an anode and a cathode.

Anodes and cathodes and methods for making and procuring the same are generally known to those having ordinary skill in the art. The electrochemical hydrogen pump includes an anode stream that introduces a gas stream comprising excess hydrogen and other impurities and contacts the gas stream with the membrane. The anode generates protons and electrons, and the protons pass through the membrane to the cathode, where the protons and electrons recombine to form hydrogen. The electrochemical hydrogen pump includes a cathode stream that allows a flow path for purified hydrogen gas to exit from the electrochemical hydrogen pump. In some embodiments, a trace amount (i.e., less than 1%) of air may be added to the anode stream to catalytically oxidize ammonia in the gas stream on the surface of the anode.

The membrane may include one or more proton-conducting materials dispersed throughout the membrane. The proton-conducting materials enhance the transfer of protons from the anode to the cathode of the electrochemical hydrogen pump. The one or more proton conducting materials may include perflourosulfonic acid-based ionomers having the general formula CₙF₍₂ₙ₊₁₎SO₃H. The proton-conducting materials may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. For example, the tetrafluoroethylene-based fluoropolymer-copolymer may have the formula C₇HF₁₃O₅S·CₙF₂ₙ, where n is an integer from 3,000 to 10,000. As another example, the ionomer may include Nafion™. In another example, the proton-conducting material may include phosphoric acid-doped polybenzimidazole.

The membrane may include one or more ammonia blocking materials. The ammonia-blocking materials mitigate the transfer of ammonia from the anode to the cathode of the electrochemical hydrogen pump. The ammonia-blocking materials may include ceria, titanium oxide, or any combination thereof.

The membrane of the electrochemical hydrogen pump may comprise multiple layers, wherein each layer includes predominantly a proton-conducting material or a hydrocarbon-based material. For example, the membrane of the electrochemical hydrogen pump may include a first proton-conducting membrane layer, a second proton-conducting membrane layer, and a hydrocarbon-based proton conducting layer disposed between and in physical contact with the first proton-conducting membrane layer and the second proton-conducting membrane layer. Each proton-conducting membrane layer may include one or more perflourosulfonic acid-based ionomers having the general formula CₙF₍₂ₙ₊₁₎SO₃H. The perflourosulfonic acid-based membrane layer may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. For example, the tetrafluoroethylene-based fluoropolymer-copolymer may have the formula C₇HF₁₃O₅S·CₙF₂ₙ, where n is an integer from 3,000 to 10,000. As another example, the ionomer may include Nafion™. In another example, the proton-conducting membrane layer may include phosphoric acid-doped polybenzimidazole.

The hydrocarbon-based proton conducting layer conducts ions similar to the ion-conducting membrane, but is further operable to prevent the permeation of hydrogen and oxygen gas to the ion-conducting membranes because the solubility of hydrogen and oxygen is much lower in the hydrocarbon-based proton conducting membrane as compared to an ion-conducting membrane. The hydrocarbon-based proton-conducting membrane is preferably cast from a gas-blocking ion-conducting resin. The gas-blocking membrane comprises a sulfonated polymer. Preferably, the sulfonated polymer is a sulfonated non-fluorinated polymer. Sulfonated polymers suitable for use in ion exchange membranes are generally known in the art. In preferred embodiments, the sulfonated polymer is selected from the group consisting of sulfonated poly(ether ether ketone) (SPEEK), sulfonated phenylated poly(phenylene) (SPPP), sulfonated poly(ether sulfone) (SPES), sulfonated polystyrene-b-poly(ethylene-r-butylene)-b-polystyrene (S-SEBS), mixtures of sulfonated poly(ethylene oxide) mixed with poly(vinyl alcohol), sulfonated polystyrene cross-linked with divinyl benzene, and combinations thereof. In particular examples, the sulfonated polymer may include Selemion™ CMV, Neosepta™ CMS, and Fumasep™ FKS 30, or combinations thereof.

Any of the membrane layers may further comprise a scaffold. The scaffold comprises a supporting polymer. Supporting polymers may be any polymer suitable for adding structural integrity to a membrane without compromising suitability of the membrane for ion exchange. In particular embodiments, the supporting polymer may include poly(ether ether ketone) (PEEK), polytetrafluoroethylene (PTFE), or polyethylene polyvinylidene fluoride (PVDF). The scaffold may be in the shape of a mesh, wherein a resin comprising the perflourosulfonic acid ionomer or the hydrocarbon-based proton conducting polymer is cast onto the scaffold and dried. Thus, the scaffold is embedded within the membrane.

Any of the membrane layers, the anode, or the cathode may further comprise a catalyst. Preferably the catalyst in the form of nanoparticles; i.e., the catalyst may be in the form of particles having a particle size of about 100 nm or less. In preferred embodiments, the nanoparticles have an average particle size of about 10 nm. The catalyst may include one of platinum, palladium, gold, iridium, osmium, rhodium, ruthenium, silver, or a combination thereof. The catalyst may be embedded in the surface of the membrane layer, or may be dispersed throughout the membrane layer.

Preferably, the catalyst used in the anode layer is tolerant to ammonia poisoning; i.e., ammonia adsorbing onto the catalyst. Nickel, nickel-platinum-based alloys, ruthenium, iridium, platinum, or any combination thereof may be used in the anode to prevent ammonia poisoning.

### IV. Ammonia Synthesis Device

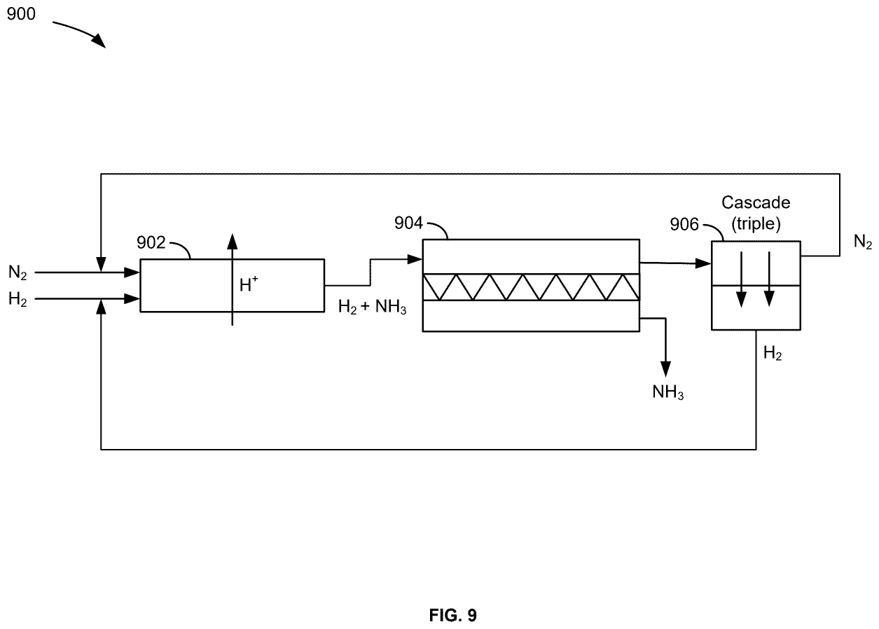

Further provided herein are ammonia synthesis devices for synthesizing ammonia. The ammonia synthesis devices described herein may be used as the reactor in any of the systems described in Section I or any of the methods described above in Section II. Turning now to FIG. 9, the ammonia synthesis device 900 generally includes an ammonia synthesis reactor 902 to generate a product gas stream comprising ammonia, excess hydrogen gas, and excess nitrogen gas; a membrane 904 fluidly connected with the electrochemical ammonia synthesis reactor to separate ammonia from the product gas stream; and an electrochemical hydrogen pump 906 to separate excess hydrogen gas from the product gas stream and compress the excess hydrogen gas. The benefit of the ammonia synthesis devices provided herein are reduced energy required for ammonia separation are required and the concentration of ammonia which must be accepted in the electrochemical hydrogen pump are reduced; therefore, the overall efficiency of the ammonia production is increased.

Electrochemical ammonia synthesis reactors and methods of making and procuring the same are generally known in the art. Electrochemical ammonia synthesis reactors particularly suitable for use in the systems of the present disclosure are described in U.S. Application No. Ser. No. 17/101,224 filed Nov. 23, 2020, the entire contents of which are incorporated by reference herein in their entirety.

Generally, the electrochemical ammonia synthesis reactor 902 and the energy source of the reactor may include a synthesis cell (e.g., a proton-exchange membrane (“PEM”) cell) operable for electrochemical synthesis of ammonia from hydrogen and nitrogen. The synthesis cell may include an anode, a cathode, and a medium. The medium may be disposed between the anode and the cathode and, for example, may be ionically conductive to protons. As a more specific example, the medium may include one or more of a proton-exchange membrane or an electrolyte. Additionally, or alternatively, the synthesis cell may include a power source connected to the anode and to the cathode to create an electric field in the medium disposed between the anode and the cathode (i.e., to apply a voltage between the anode and the cathode). In this embodiment, the energy provided by the energy source is electrical energy (i.e., a voltage). The energy source may include additional instances of the synthesis cell (e.g., as part of an electrochemical stack).

In other embodiments, the ammonia synthesis reactor may be a Haber-Bosch reactor, which synthesizes ammonia via the Haber-Bosch process.

The ammonia synthesis reactor 902 may include a hydrogen stream inlet for feeding hydrogen gas into the ammonia synthesis reactor. The ammonia synthesis reactor 902 may include a nitrogen stream inlet for feeding hydrogen gas into the ammonia synthesis reactor. The ammonia synthesis reactor 902 may include an outlet to move the ammonia and excess hydrogen gas and other impurities out of the ammonia synthesis reactor.

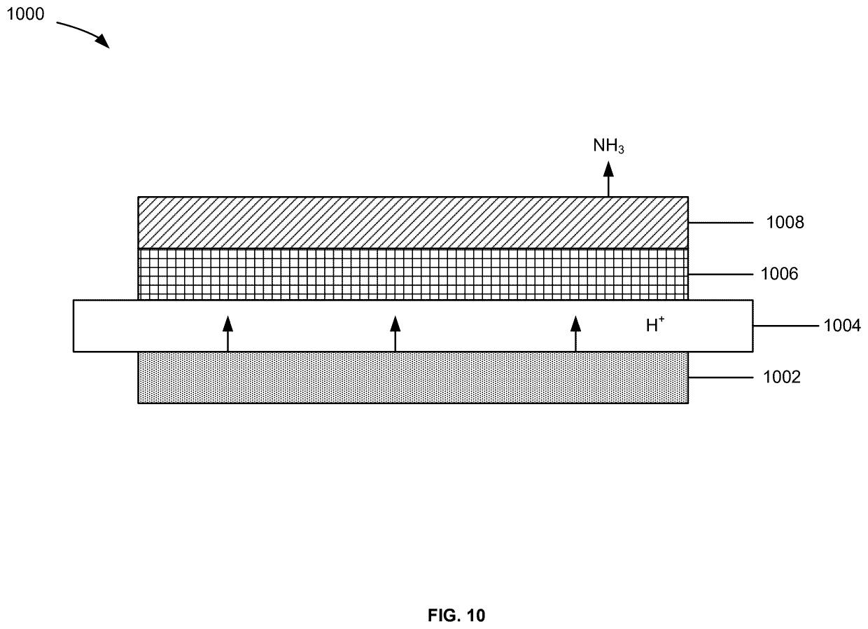

The ammonia synthesis reactor 902 may operate by electrochemically reducing nitrogen gas to ammonia. The electrochemical ammonia synthesis reactor 902 medium may include an ammonia transport layer to enhance the formation of ammonia and reduce the diffusion of ammonia back to the anode. Referring now to FIG. 10, the synthesis cell 1000 of the electrochemical ammonia synthesis reactor 902 may include an anode 1002, a membrane 1004 such as a proton exchange membrane, a cathode 1006, and an ammonia transport layer 1008. The membrane 1004 is disposed between and is in physical contact with the anode 1002 and the cathode 1006. The cathode 1006 is disposed between and is in physical contact with the membrane 1004 and the ammonia transport layer 1008. The cathode 1006 includes flow paths to allow the ammonia and other gases to flow to and make contact with the ammonia transport layer 1008.

The ammonia transport layer 1008 may be a composite membrane including an ammonia conducting material and an electronic conducting material. The ammonia transport layer 1008 is porous to allow gas transport across the layer. The ammonia conducting material may include, e.g., Prussian blue analogues. Non-limiting examples of Prussian blue analogues suitable for this purpose include metal hexacyanoferrates, such as copper hexacyanoferrate, nickel hexacyanoferrate, or any combination thereof. The electronic conducting material may include carbon. The carbon may have a high surface area, such as carbon black. The composite membrane may further include an inert porous material to strengthen the composite membrane. The inert porous material may include, for example, poly(ether ether ketone) (PEEK), polytetrafluoroethylene (PTFE), or polyethylene polyvinylidene fluoride (PVDF).

Returning to FIG. 9, the membrane 904 may be a membrane diffusion-type separator discussed above in Section I. The membrane 904 separates ammonia from excess nitrogen gas, excess hydrogen gas, and other impurities by diffusion across a membrane. The membrane may include non-porous polymeric hollow fibers. Accordingly, the membrane 904 is fluidly connected to the ammonia synthesis reactor 902.

The membrane 904 may receive the ammonia and other gases at a pressure from about 110 bar to about 130 bar (gauge). The separated ammonia may exit the membrane 904 at a pressure from about 25 bar to about 70 bar (gauge). In some embodiments, the membrane may have a capacity from about 4,000 Nm³/h to about 40,000 Nm³/h.

The electrochemical hydrogen pump 906 may be any electrochemical hydrogen pump known in the art, or it may be an electrochemical hydrogen pump as described in Section III above. The electrochemical hydrogen pump separates and compresses excess hydrogen gas from an outlet stream of the membrane 904. The separated hydrogen gas may then be recirculated to an inlet of the ammonia synthesis reactor 902 to be reused in the reaction. The excess nitrogen gas and other impurities that remain may also be recirculated to an inlet of the ammonia synthesis reactor 902, or they may be vented to the atmosphere. Accordingly, the electrochemical hydrogen pump 906 is fluidly connected to the membrane 904 and to the ammonia synthesis reactor 902.

Although only a single instance of an electrochemical hydrogen pump is shown in FIG. 9, it should be understood that multiple electrochemical hydrogen pumps may be connected in series (i.e., in a stack) to further increase compression and purity of the hydrogen gas.

In the embodiment shown in FIG. 9, the recirculation of nitrogen and hydrogen separated by the electrochemical hydrogen pump 906 to one or more inlets of the ammonia synthesis reactor 902 provides stoichiometric control of the reactants to improve the overall efficiency of the ammonia synthesis. Specifically, the amount of hydrogen gas and nitrogen gas fed to the ammonia synthesis reactor 902 may be precisely controlled by adjusting the flow rate of hydrogen gas and/or nitrogen gas from a hydrogen source and/or nitrogen source, respectively. This configuration also increases conversion of all reactants in the system and reduces losses to the atmosphere.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or. ”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

The above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

Embodiments disclosed herein may include computer program products comprising computer-executable code or computer-usable code that, when executing on one or more computing devices, performs any and/or all of the steps of the control systems described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the control systems described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A method for recovering hydrogen gas in an ammonia production system comprising:
reacting hydrogen gas and nitrogen gas in a reactor to produce a product gas stream comprising ammonia and excess hydrogen gas;
separating the ammonia from the product gas stream;
separating the excess hydrogen gas from the product gas stream using an electrochemical hydrogen pump to recover the excess hydrogen gas to recover the excess hydrogen gas; and
compressing the excess hydrogen gas using the electrochemical hydrogen pump.

2. The method of claim 1, further comprising reacting the recovered excess hydrogen gas and nitrogen gas to produce ammonia.

3. The method of claim 1, further comprising separating a fraction of the excess hydrogen gas from the product gas stream using a diffusion-type membrane separator, thereby producing a recovered hydrogen gas stream and a diffusion-separated product stream.

4. The method of claim 3, further comprising separating additional hydrogen gas from the diffusion-separated gas stream and compressing the additional hydrogen gas using an electrochemical hydrogen pump.

5. The method of claim 4, further comprising recirculating the additional hydrogen gas to an inlet of the reactor.

6. The method of claim 1, further comprising humidifying the excess hydrogen gas stream prior to step separating the excess hydrogen gas from the product gas stream.

7. The method of claim 1, further comprising powering the electrochemical hydrogen pump using a hydrogen fuel cell.

8. The method of claim 7, further comprising fueling the hydrogen fuel cell using at least a fraction the excess hydrogen gas.

9. A system for ammonia synthesis comprising:
a reactor for producing a product gas stream comprising ammonia, the reactor fluidly connected to a hydrogen source and a nitrogen source;
a flash vessel fluidly connected to the reactor for separating ammonia from the product gas stream, thereby producing a separated gas stream; and
an electrochemical hydrogen pump fluidly connected to the flash vessel to separate excess hydrogen gas from the separated gas stream and to compress the excess hydrogen gas.

10. The system of claim 9, further comprising a multi-stage compressor fluidly connected to the reactor for compressing hydrogen gas from the hydrogen source and nitrogen gas from the nitrogen source.

11. The system of claim 9, further comprising a diffusion-type membrane separator fluidly connected to the reactor to separate hydrogen gas from the product gas stream.

12. The system of claim 11, further comprising a recirculation loop fluidly connected to the diffusion-type membrane separator and an inlet of the reactor to recirculate the separated hydrogen gas to the inlet of the reactor.

13. The system of claim 9, wherein the hydrogen source includes a steam methane reformer.

14. The system of claim 9, further comprising a second electrochemical hydrogen pump fluidly connected to an outlet of the reactor to separate hydrogen gas from the product gas stream.

15. The system of claim 14, further comprising a recirculation loop fluidly connected to the second electrochemical hydrogen pump and an inlet of the reactor to recirculate the separated hydrogen gas to the inlet of the reactor.

16. A method for recovering hydrogen gas in an ammonia production system comprising:
reacting hydrogen gas and nitrogen gas to produce a gas stream comprising ammonia and excess hydrogen gas;
separating the excess hydrogen gas from the gas stream using an electrochemical hydrogen pump to recover the excess hydrogen gas; and
compressing the excess hydrogen gas using the electrochemical hydrogen pump.

17. An electrochemical hydrogen pump comprising a membrane disposed between an anode and a cathode, the membrane comprising:
one or more proton-conducting materials; and
one or more ammonia-blocking materials.

18. The electrochemical hydrogen pump of claim 17, wherein the one or more proton-conducting materials include perflourosulfonic acid-based polymers.

19. The electrochemical hydrogen pump of claim 17, wherein the one or more ammonia-blocking materials include ceria, titanium oxide, or a combination thereof.

20. The electrochemical hydrogen pump of claim 17, wherein the membrane includes:
a first perflourosulfonic acid-based membrane layer;
a second perflourosulfonic acid-based membrane layer; and
a hydrocarbon-based proton conducting layer disposed between and in physical contact with the first perflourosulfonic acid-based membrane layer and the second perflourosulfonic acid-based membrane layer.
